(19) United States
(12) Patent Application Publication
(10) Pub. No.: US 2012/0025558 A1
(43) Pub. Date: Feb. 2, 2012

(54) FLOORBOARDS FOR PERSONAL MOTORIZED VEHICLES AND METHODS OF INSTALLING

(76) Inventor: John Anderson, Newberg, OR (US)

(21) Appl. No.: 12/846,360

(22) Filed: Jul. 29, 2010

(51) Int. Cl. B62J 25/00

(52) U.S. Cl. 296/75

(57) ABSTRACT

Floorboards for personal motorized vehicles and methods of installing are disclosed herein. Preferred floorboards, when installed, include means for allowing a user to operate a brake pedal positioned below floorboards. Additionally, the floorboards herein can also include means to allow a rider to manually shift using a foot shifter's socket. Installation of the floorboards herein does not require any significant physical alterations to the actual vehicle, such as drilling or welding to the body of the vehicle. Alterations to the vehicle for the floorboards described herein are expressly reversible.

### FIELD OF THE INVENTION

The invention described herein generally relates to floorboards for a personal motorized vehicle.

### BACKGROUND

Floorboards for personal motorized vehicles, including motorcycles and 3-wheelers, have been used to allow a user to alternate foot positioning during rides. Current floorboards either do not have a large enough foot resting surface area or do not handle the problems associated with accessing the brakes and/or shifting devices through the floor boards.

The new floorboards and methods described herein have many advantages over the prior art. More specifically, the new embodiments herein allow users a large surface area to alternate foot positioning during rides, are quickly attachable to and detachable from the vehicle without invasive physical alteration, are aesthetically pleasing, and can allow a user to functionally access a foot brake and/or a foot shifter positioned below the floorboards

### SUMMARY OF THE INVENTION

The teachings herein are directed to assemblies for releasably attaching first and second floorboards respectively onto first and second sides of a personal motorized vehicle having a brake pedal positioned on the first side and comprising: a first floorboard with an upper surface having a horizontally leveled section with a vertical aperture and an underside that includes means for releasably attaching to a topside of a first foot peg positioned on the first side of the vehicle; a first support bracket having a horizontal extension and configured to releasably attach to the first side of the vehicle such that the horizontal extension is substantially level with the topside of the first foot peg, and wherein the horizontal extension is adapted to releasably attach to the underside of the first floorboard; a brake extension having means for releasably attaching to a brake pedal positioned on the first side of the vehicle and being configured to traverse through the vertical aperture in the first floorboard; a second floorboard with an upper surface having a horizontally leveled section and an underside that includes means for releasably attaching to a topside of a second foot peg positioned on the second side of the vehicle; a second support bracket having a horizontal extension and configured to releasably attach to the second side of the vehicle such that the horizontal extension is substantially level with the topside of the second foot peg, and wherein the horizontal extension is adapted to releasably attach to the underside of the second floorboard.

Further embodiments are directed to methods of releasably attaching first and second floorboards respectively onto first and second sides of a personal motorized vehicle, comprising: providing a personal motorized vehicle having a first foot peg with a topside and a brake pedal positioned on the first side and a second foot peg with a topside positioned on the second side; providing a first floorboard with an upper surface having a horizontally leveled section with a vertical aperture to allow a brake extension to pass through and an underside; providing a first support bracket having a horizontal extension; providing a brake extension; providing a second floorboard with an upper surface having a horizontally leveled section and an underside; providing a second support bracket having a horizontal extension; releasably attaching the first support bracket to the first side of the vehicle, such that the horizontal extension of the first support bracket is level with the topside of the first foot peg; releasably attaching the brake extension to the brake pedal; releasably attaching the first floorboard to the topside of the first foot peg and the horizontal extension of the support bracket such that the brake extension traverses through the vertical aperture past the upper surface of the first floorboard and allows a rider to apply pressure to the brake pedal; releasably attaching the second support bracket to the second side of the vehicle, such that the horizontal extension of the support bracket is level with the topside of the second foot peg; and releasably attaching the second floorboard to the topside of the second foot peg and the horizontal extension of the second support bracket.

### BRIEF DESCRIPTION OF THE DRAWINGS

It will be appreciated that the drawings are not necessarily to scale, with emphasis instead being placed on illustrating the various aspects and features of the invention, in which:

FIG. 1 is a perspective view of a right side motorcycle aluminum assembly.

FIG. 2 is an exploded view of a right side support bracket.

FIG. 3 is an exploded view of a right side floorboard being installed to the aluminum assembly.

FIG. 4 is a perspective view of a right side floorboard installed to the aluminum assembly.

FIG. 5 is a perspective view of a left side motorcycle aluminum assembly.

FIG. 6 is an exploded view of a left side support bracket.

FIG. 7 is an exploded view of a left side floorboard being installed to the aluminum assembly.

FIG. 8 is a perspective view of a left side floorboard installed to the aluminum assembly.

FIG. 9 is a front perspective view of a shift lever extension.

FIG. 10 is a back perspective view of a shift lever extension.

FIG. 11 is an exploded view of a foot shifter peg being removed from a left side shifter assembly.

FIG. 12 is an exploded view of a shift lever extension being installed into a left side shifter assembly.

FIG. 13 is an exploded view of a shift lever extension and left side floor board being installed.

FIG. 13A is a perspective view of a left side floorboard and shift lever assembly installed.

FIG. 14 is an exploded view of a left side floorboard and heel/toe shifter being installed.

FIG. 15 is a perspective view of a left side floorboard and heel/toe shifter installed.

FIG. 16 is an exploded view of an alternative right side support bracket.

FIG. 17 is an exploded view of an alternative left side support bracket.

FIG. 18 is a front perspective view of an alternative shift lever extension.

### DETAILED DESCRIPTION OF THE ILLUSTRATED EMBODIMENTS

Embodiments of the present invention are described below. It is, however, expressly noted that the present invention is not limited to these embodiments, but rather the intention is that modifications that are apparent to the person skilled in the art and equivalents thereof are also included.

In general, the teachings herein are directed floorboards and methods of installation. While most embodiments herein are directed to floorboards designed for and methods of installing to BRP's CAN-AM SPYDER 2010 RS models (i.e., RS and RS-S models), those with skill in the art can recognize using the teachings herein on other personal motorized vehicles where applicable, including potential future models of the CAN-AM SPYDER. For non SPYDER vehicles, the support brackets can be attached to any suitable part of the vehicle's side, as opposed to an aluminum assembly, for example.

Embodiments of the invention will now be described with reference to the accompanying figures, wherein like numerals refer to like elements throughout. The terminology used in the description presented herein is not intended to be interpreted in any limited or restrictive manner simply because it is being utilized in conjunction with a detailed description of certain specific embodiments of the invention.

### Right Side Floorboard

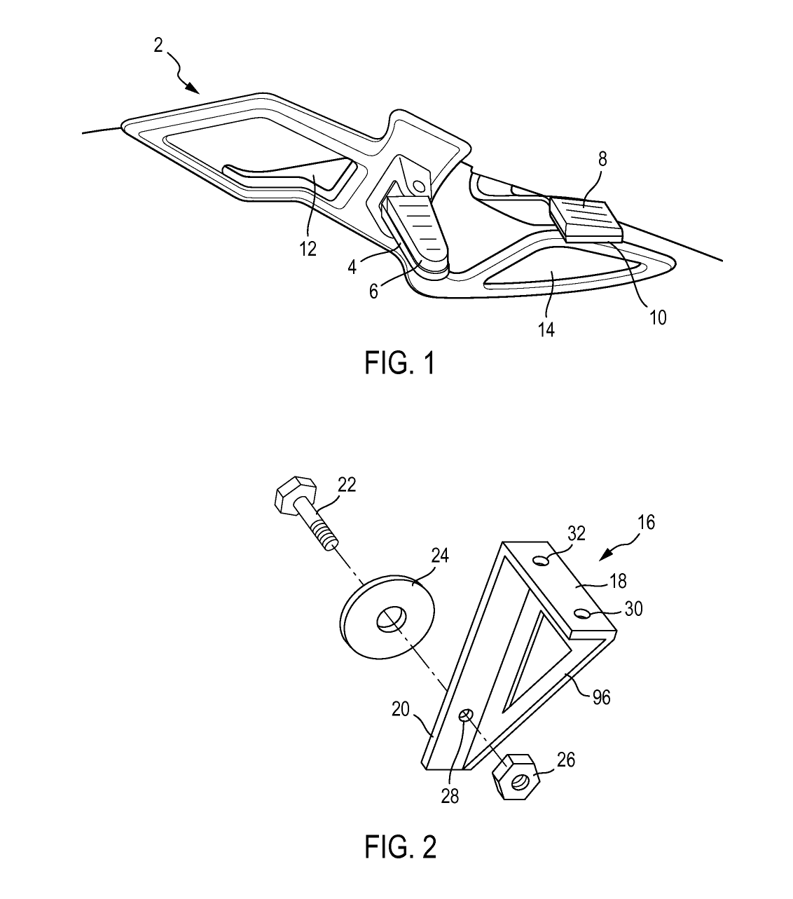

FIG. 1. is a perspective view of an aluminum assembly 2 positioned on the right side of a CAN-AM SPYDER, RS model. The right side aluminum assembly 2 includes a back slot 12, a front slot 14, and a right foot peg 4 with a protective cover 6. The brake pedal 10 and its cover 8 are positioned in close proximity to the right side aluminum assembly 2, in front of the right foot peg 4. As is well known in the art, when a rider applies sufficient downward pressure on the brake pedal 10, the vehicle's braking mechanism will be activated.

FIG. 2. is an exploded view of an exemplary right side support bracket 16. According to certain embodiments the right side support bracket 16 is in the shape of an inverted L, having a vertical member 20 whose top end is coupled to a horizontal member 18 that extends away from the motorcycle and includes a topside having two vertical apertures 32 and 30. According to specific embodiments the horizontal member 18 is between 7-12 inches long and between 0.75-2 inches wide, or even more particularly 9.5 inches long and 1 inch wide, or substantially so. The two vertical apertures 32 and 30 can be sized to be used with the desired fastening means, and can preferably be 9/32 inches, for example. The vertical member 20 is preferably between 4-6 inches tall and between 0.75-2 inches wide, or even more particularly 5⅝ inches tall and 1 inch wide, or substantially so.

Additional features can be added to the right side support bracket 16. For example, one or more, supporting members can also be used to enhance the load bearing capacity of the horizontal member 18 and overall stability of the right side support bracket 16. As one example, a triangular shaped supporting member 96 can be used to further support the coupling of the vertical 20 and horizontal members 18. The right side supporting bracket 16 can be constructed using any suitable materials, such as a carbon fiber, fiberglass, reinforced fiberglass, hard plastic, metal, non-exclusively including steel, aluminum, bronze, and the like. Likewise, depending on the materials used, the right side supporting bracket 16 can be constructed using any suitable method, such as molding, casting, welding, and bending sheet metal.

Any suitable fastening means can be used to releasably secure the right side support bracket 16 to the front slot 14 of the aluminum assembly 2. FIG. 2 depicts one, non-exclusive way that involves a bolt 22, and a complementary washer 24 and nut 26 configured to secure the bracket 16 through a horizontal aperture 28 positioned in the vertical member 20. Other alternative fastening means are known in art, including the use of more than one bolt, the use of one or more threaded holes in the support bracket 16 configured to receive one or more bolts, and one or more securing tabs and/or bolts on the support bracket 16 and complementary fastening means to fasten to the right side aluminum assembly 2. According to preferred embodiments, the aluminum assembly 2 does not have to be permanently altered, such as incurring drilling or welding to secure the right side support bracket 16. Preferred fastening means and methods are readily reversible, such as through the use of releasable fasteners.

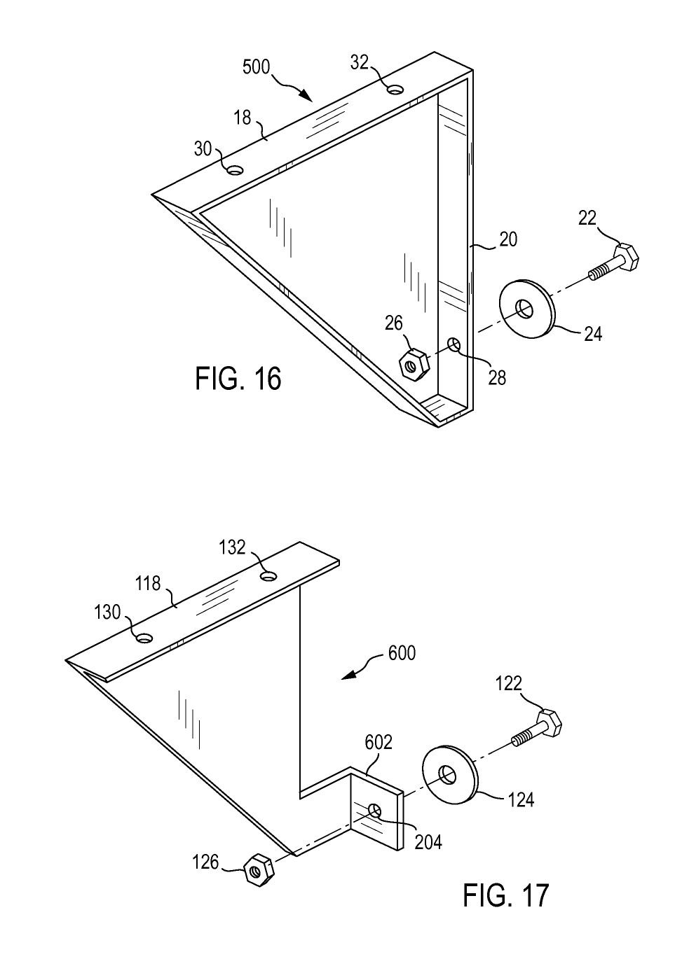

Other suitable shaped support brackets can also be used with the teachings herein. FIG. 16 provides another non-exclusive example of a right sided support bracket 500 with the horizontal member 18 forming the upper side, and the vertical member 20 forming the proximal side. Preferably the right sided support bracket 500 can be formed from a single piece of sheet metal and folded such that the sides (e.g., 18, 28, etc.) extend frontwards, away from the brake pedal 10, instead of backwards as shown in FIG. 2. This alternate support bracket 500 can be coupled to the front slot 14 identically to how the right support bracket 16 shown in FIG. 2 is. One preferred example involves a bolt 22, and a complementary washer 24 and nut 26 configured to secure the bracket 500 through a horizontal aperture 28 positioned in the vertical member 20. Materials and methods of making the alternate right support bracket 500 can be the same as those used for the right support bracket 16 shown in FIG. 2.

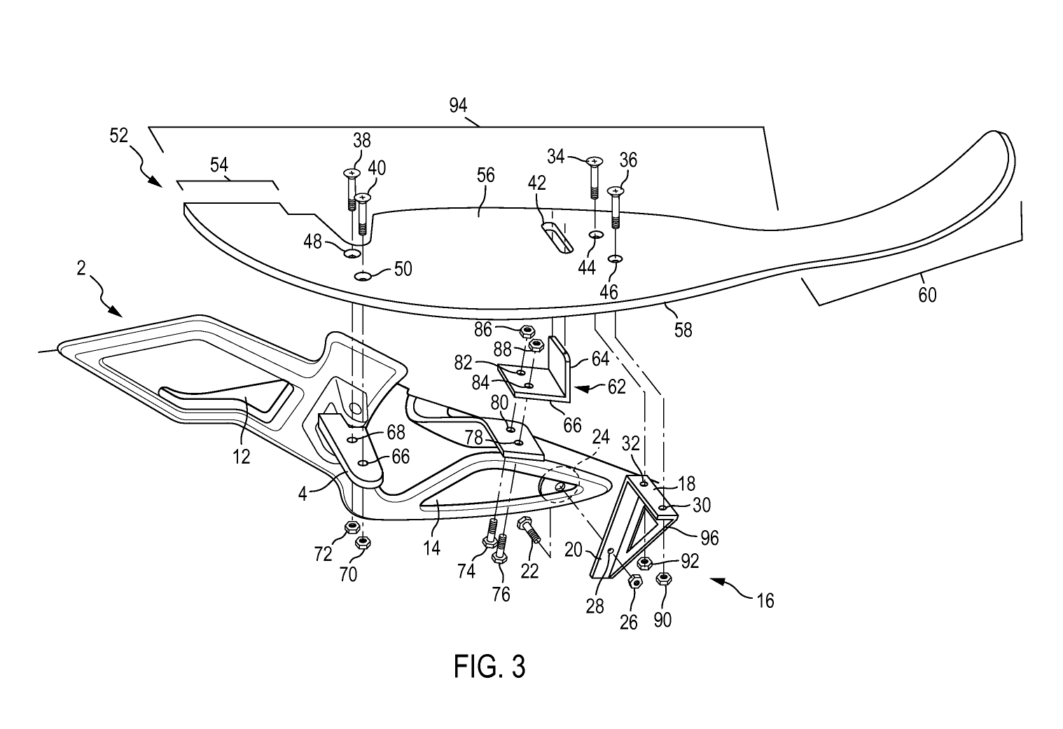

FIG. 3 provides an exploded view of a right side floorboard 52 being installed on the right side aluminum assembly 2. According to preferred embodiments, no part of the aluminum assembly 2 or right side of the vehicle is permanently altered (e.g., welding, drilling, etc.) to allow attachment or detachment of the right floorboard 52. According to preferred teachings herein, the only reversible physical alterations to the actual right side of the vehicle involve the removal of the cover 6 of the foot peg 4, thereby exposing two vertical apertures 66 and 68, and the cover 8 of the brake pedal 10 to expose another two vertical apertures 78 and 80. Both the foot peg cover 6 and the brake pedal cover 8 can be readily reattached if so desired.

In general, the right side floorboard 52 includes a top surface 56 to allow a rider to position their right foot on and an undersurface 58 for mounting to the foot peg 4 and the horizontal member 18 of the right side support bracket 16. Preferably the floorboard 52 is non-exclusively between 20-35 inches long, from front to back, or between 25-35 inches, or even more particularly 31.5 inches, or substantially so. One non-exclusive preferred surface area range of the top surface 56 could be 135-240 square ft. The top surface 56 thus preferably has a substantial surface area and allows a rider multiple positions for their right foot, including, for example: forward and back positions, level and elevated positions, and positions proximal and distal from the bike. Enhanced surface area allows the right floorboard 52 to act as a water, oil, and mud guard, and protects the rider from these substances being kicked up from the road. The floorboard 52 can non-exclusively have a thickness between ⅛ inches-¾ inches, or even more preferably 3/16 inches, or substantially so.

The top surface 56 can be powder coated or otherwise constructed to allow sufficient traction to prevent slippage of the rider's right foot. The right side floorboard 52 can be constructed out of any suitable material for supporting a rider, including steel, aluminum, carbon-fiber, reinforced fiberglass, and fiberglass, for example. The right side floorboard 52 can also be constructed using any suitable method depending on the construction material, such as casting, welding, molding, cutting, bending, and the like.

According to certain embodiments the right floorboard 52 includes a horizontally leveled section 94 and a frontward, upwardly angled section 60. The frontward, upwardly angled section 60 is preferably narrower than the horizontally leveled section 94 and rises forward at an angle of between 25-45 degrees, or 30-40 degrees, or even more specifically 33 degrees, or substantially so. According to other embodiments, the floorboard is entirely level, such that the frontward, upwardly angled section 60 is not present. With respect to the horizontally leveled section 94, the underside 58 of the floorboard 52 can be positioned on top of the exposed foot peg 4 and the horizontal member 18 of the support bracket 16. As such the topside of the horizontal member 18 of the support bracket 16 is preferably constructed or otherwise configured to be horizontally level with the exposed foot peg 4 when installed. This preferred configuration allows for the floorboard 52 to be positioned at substantially the same height as the foot peg 4 with cover 6, or the preferred foot position intended by the designer of the particular vehicle, such as the CAN-AM SPYDER, RS models.

The back of the floorboard 52 includes a back tab 54 configured to be inserted into the back slot 12 of the right side aluminum assembly 2. Positioned frontwards and distally away of the back tab 54 is a back set of vertical apertures 48 and 50, configured to receive fastening means (e.g., bolts, hex bolts, screws). A vertical aperture 42 sized to allow the vertical member 64 of a brake extension 62 to pass through is positioned in front of the back set of vertical apertures 48 and 50. A front set of vertical apertures 44 and 46 configured to receive fastening means (e.g., bolts, hex bolts, screws) is positioned frontwards of the brake aperture 42 near the front of the horizontally leveled section 94. The back set of vertical apertures 48 and 50 and the front set of vertical apertures 44 and 46 can be sized to accommodate the selected fastening means and vice versa. According to one preferred embodiment, ¼ inch hex bolts are used.

According to highly advantageous embodiments, when the back tab 54 of the right floorboard 52 is installed into the back slot 12 of the aluminum assembly 2, the back set of vertical apertures 48 and 50 are respectively aligned with the vertical apertures 68 and 66 of the foot peg 4. Once aligned, fastening means, such as bolts 38 and 40 can be passed through and secured using nuts 72 and 70. Washers can be included in the fastening means if so desired.

Similarly, when the back tab 54 of the right floorboard 52 is installed into the back slot 12 of the aluminum assembly 2, the front set of vertical apertures 44 and 46 on the floorboard 52 are respectively aligned with the vertical apertures 32 and 30 on the horizontal member 18 of the right side support bracket 16. Once aligned, fastening means, such as bolts 34 and 36 can be passed through and secured using nuts 92 and 90. Washers can be included in the fastening means if so desired.

With the back tab 54 installed in the back slot 12, the back set of vertical apertures 48 and 50 securely fastened to the foot peg 4, and the front set of vertical apertures 44 and 46 securely fastened to the right side support bracket 16, the right side floorboard 52 is very stable, and the horizontally leveled section 94 can easily support the entire weight of at least a 250 lb rider.

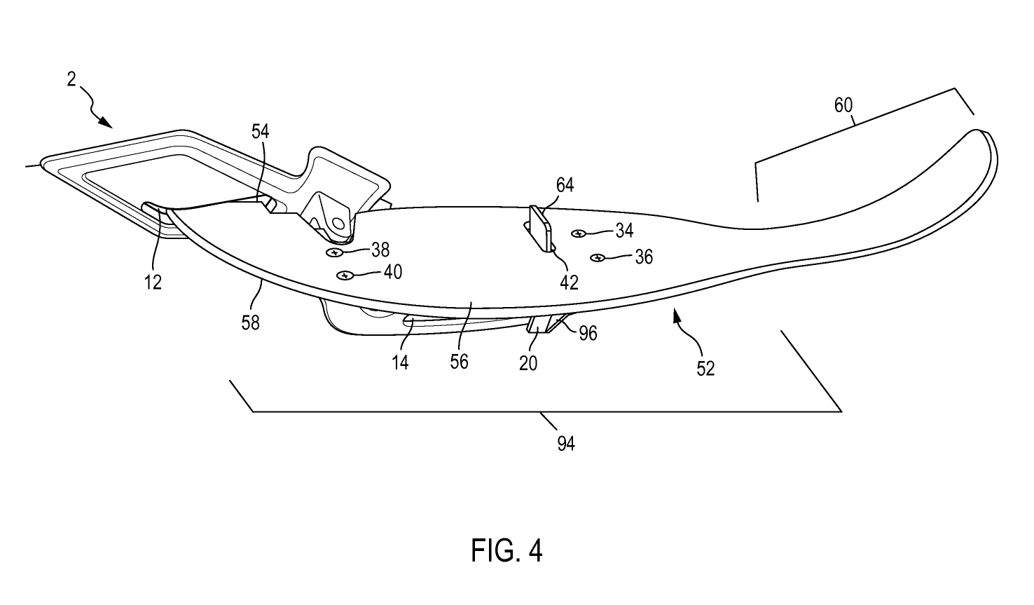

As shown in FIG. 4, when the back tab 54 of the right floorboard 52 is installed into the back slot 12 of the aluminum assembly 2, the vertical member 64 of the brake extension 62 is aligned to vertically traverse through the brake aperture 42. More specifically, the brake extension 62 is mounted to the exposed brake pedal 10 using any suitable means, but preferably through the use of the existing vertical apertures 78 and 80 on the brake pedal 10. The brake extension 62 can be L-shaped, V-shaped, or substantially so, having a horizontal member 66 coupled at either a right angle, or otherwise, to a vertical member 64. When the vertical member 64 is angled, it is preferable that it is angled backwards to define an acute angle with the horizontal member 66. The horizontal member 66 can include two vertical apertures 84 and 82 that respectively align with the two vertical apertures 78 and 80 when the horizontal member 66 is positioned on top of the exposed brake pedal 10. A first bolt 76, or other fastening means, can traverse through both apertures 78 and 80 and be secured using a nut 88. Likewise a second bolt 74 or other fastening means can traverse through both apertures 80 and 82 and be secured using a second nut 86. Washers can also be used with these fastening means.

When installed, and as shown in FIG. 4, the vertical member 64 of the brake extension 62 is configured to pass through a vertical aperture 42 within the right floorboard 52, at a sufficient distance to allow the rider to readily press downward on the vertical member 64 and thus the coupled brake pedal 10 to actuate the braking mechanism of the vehicle. The vertical member 64 can include more top surface area than shown in FIGS. 3 and 4, preferably extending backwards, and can include a slip resistant surface, such as a rubber cover and/or tread, for example.

### Left Side Floorboard

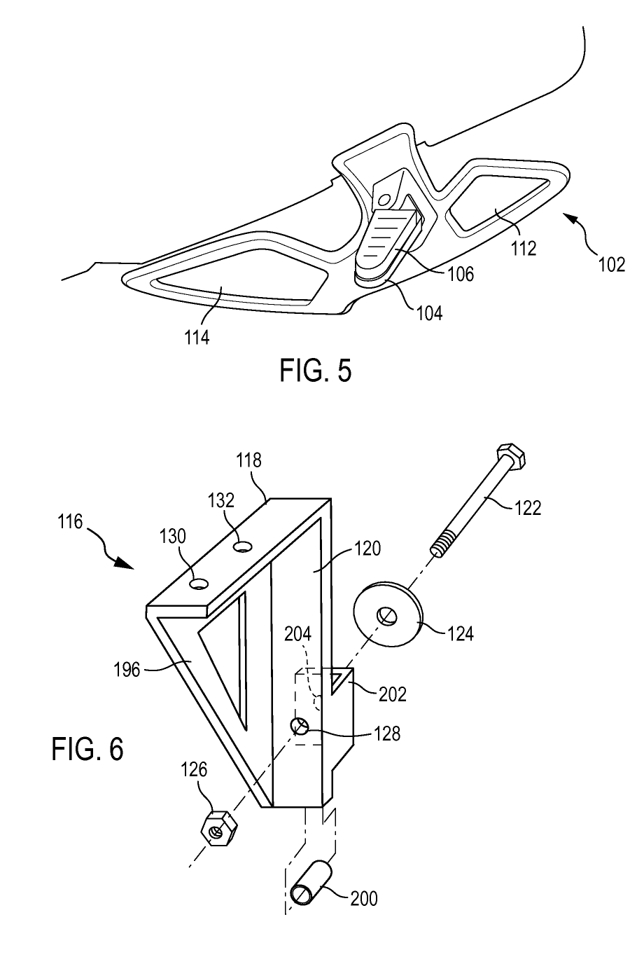

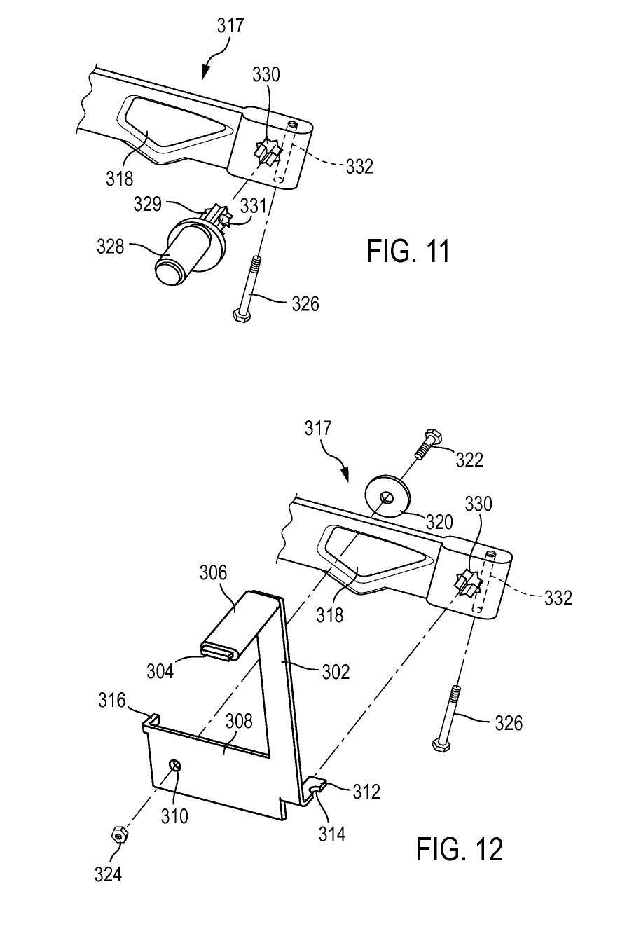

FIG. 5. is a perspective view of an aluminum assembly 102 positioned on the left side of a CAN-AM SPYDER, RS model. The left side aluminum assembly 102 includes a back slot 112, a front slot 114, and a left foot peg 104 with a protective cover 106. Vehicles with hand operated shifting, such as automatic or semi-automatic shifting may not include a foot shifter peg on the left side. Alternatively the vehicle may have manual shifting and thus include a left side foot shifter peg 328 (see FIG. 11, for example). As will be discussed in detail below, the left side floorboards 152 herein can accommodate each of these types of transmissions.

FIG. 6. is an exploded view of an exemplary left side support bracket 116. According to certain embodiments the left side support bracket 116 is in the shape of an inverted L, having a vertical member 120 whose top end is coupled to a horizontal member 118 that extends away from the motorcycle and includes a topside having two vertical apertures 132 and 130. According to specific embodiments the horizontal member 118 is between 5-9 inches long and between 0.75-2 inches wide, or even more particularly 7.75 inches long and 1 inch wide, or substantially so. The two vertical apertures 132 and 130 can be sized to be used with the desired fastening means, and can preferably be 9/32 inches, for example. The vertical member 120 is preferably between 3-5.5 inches tall and between 0.75-2 inches wide, or even more particularly 4.75 inches tall and 1 inch wide, or substantially so.

Additional features can be added to the left side support bracket 116. For example, one or more, supporting members can also be used to enhance the load bearing capacity of the horizontal member 118 and overall stability of the right side support bracket 16. As one example, a triangular shaped supporting member 196 can be used to further support the coupling of the vertical 120 and horizontal members 118. The left side supporting bracket 116 can be constructed using any suitable materials, such as a carbon fiber, fiberglass, reinforced fiberglass, hard plastic, metal, non-exclusively including steel, aluminum, bronze, and the like. Likewise, depending on the materials used, the left side supporting bracket 116 can be constructed using any suitable method, such as molding, casting, welding, and bending sheet metal.

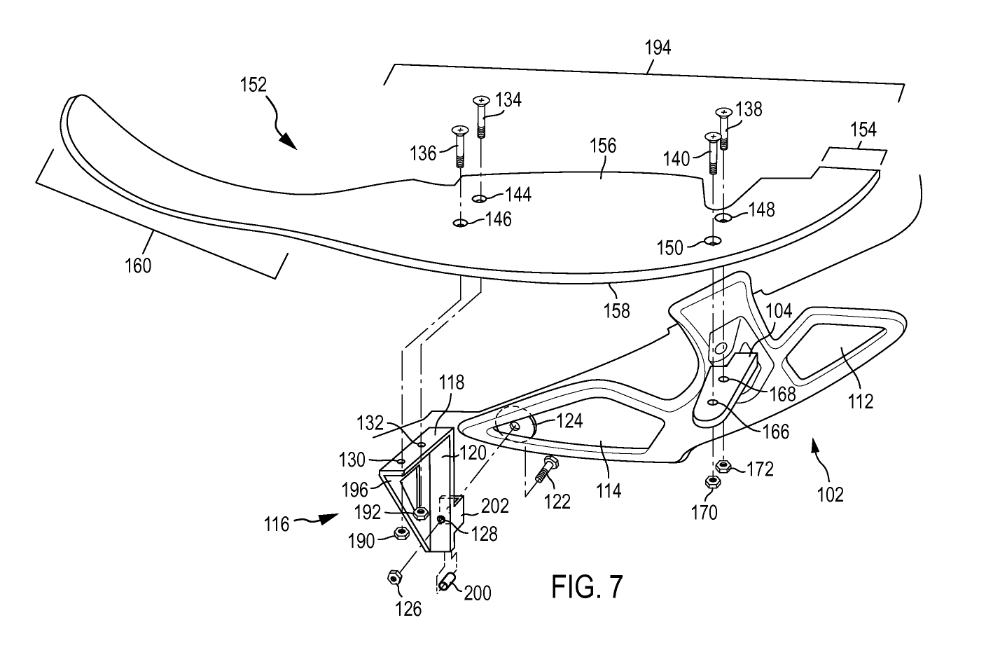

Any suitable fastening means can be used to releasably secure the left side support bracket 116 to the front slot 114 of the left side aluminum assembly 102. FIGS. 6 and 7 depict one, non-exclusive way that involves a bolt 122, and a complementary washer 124 and nut 126 configured to secure the bracket 116 through a horizontal aperture 128 positioned in the vertical member 120. More specifically, the left bracket 116 can also include a lower L-shaped extension 202 that includes a first member that traverses towards the vehicle and is connected to the vertical member 120 and a second member that traverses towards the front of the vehicle and is perpendicular to and connects to the first member. This second member can include a horizontal aperture 204 that aligns with the horizontal aperture 128 positioned in the vertical member 120 to allow the securing means, such as a bolt 122 to traverse through. A hollow spacer 200 sized to allow passage of the bolt 122 and configured to fit between the aligned horizontal apertures 204 and 128 can also be used with this embodiment. This spacer 200 can be about 0.75-1.5 inches long, or more preferably 1 inch long. Other alternative fastening means are known in art, including the use of more than one bolt, the use of one or more threaded holes in the support bracket 116 configured to receive one or more bolts, and one or more securing tabs and/or bolts on the support bracket 116 and complementary fastening means to fasten to the left side aluminum assembly 2. According to preferred embodiments, the left aluminum assembly 102 does not have to be permanently altered, such as incurring drilling or welding to secure the left side support bracket 116. Preferred fastening means and methods are readily reversible, such as through the use of releasable fasteners.

Other suitable shaped left support brackets can also be used with the teachings herein. FIG. 17 provides another non-exclusive example of a left sided support bracket 600 with the horizontal member 118 forming the upper side and a proximal side 602 facing the bike for installation thereto. This alternate left side support bracket 600 can be coupled to the front slot 114 identically to how the left support bracket 116 shown in FIGS. 6 and 7 is. One preferred example involves a bolt 122, and a complementary washer 124 and nut 126 configured to secure the bracket 600 through a horizontal aperture 204 positioned in the proximal side 602. Materials and methods of making the alternate left support bracket 600 can be the same as those used for the left support bracket 116 shown in FIG. 6.

FIG. 7 provides an exploded view of a left side floorboard 152 being installed on the left side aluminum assembly 102. According to preferred embodiments, and similar to the right side, no part of the aluminum assembly 102 or left side of the vehicle is permanently altered (e.g., welding, drilling, etc.) to allow attachment or detachment of the left floorboard 152. According to preferred teachings herein, the only reversible physical alterations to the actual left side of the vehicle involve the removal of the cover 106 of the foot peg 104, thereby exposing two vertical apertures 166 and 168. The foot peg cover 106 can be readily reattached if so desired. For embodiments related to installation of shift lever extensions 300 and 700, and heel/toe extenders 408 (discussed below) the foot shifter peg 328 should be removed from its socket 330 by unscrewing the locking bolt 326. This alteration is also readily reversible by reinserting the locking 326 bolt.

In general, the left side floorboard 152 includes a top surface 156 to allow a rider to position their left foot on and an undersurface 158 for mounting to the foot peg 104 and the horizontal member 118 of the left side support bracket 116. Preferably the floorboard 152 is non-exclusively between 20-35 inches long, from front to back, or between 25-35 inches, or even more particularly 31.5 inches, or substantially so. One non-exclusive preferred surface area range of the top surface 156 could be 135-240 square ft. The top surface 156 thus preferably has a substantial surface area and allows a rider multiple positions for their left foot, including, for example: forward and back positions, level and elevated positions, and positions proximal and distal from the bike. Enhanced surface area allows the left floorboard 152 to act as a water, oil, and mud guard, and protects the rider from these substances being kicked up from the road. The left floorboard 152 can non-exclusively have a thickness between ⅛ inches-¾ inches, or even more preferably 3/16 inches, or substantially so.

The top surface 156 can be powder coated or otherwise constructed to allow sufficient traction to prevent slippage of the rider's left foot. The left side floorboard 152 can be constructed out of any suitable material for supporting a rider, including steel, aluminum, carbon-fiber, reinforced fiberglass, and fiberglass, for example. The left side floorboard 152 can also be constructed using any suitable method depending on the construction material, such as casting, welding, molding, cutting, bending, and the like.

According to certain embodiments the left floorboard 152 includes a horizontally leveled section 194 and a frontward, upwardly angled section 160. The frontward, upwardly angled section 160 is preferably narrower than the horizontally leveled section 194 and rises forward at an angle of between 25-45 degrees, or 30-40 degrees, or even more specifically 33 degrees, or substantially so. According to other embodiments, the left floorboard is entirely level, such that the frontward, upwardly angled section 160 is not present. With respect to the horizontally leveled section 194, the underside 158 of the floorboard 152 can be positioned on top of the exposed foot peg 104 and the horizontal member 118 of the support bracket 116. As such the topside of the horizontal member 118 of the support bracket 116 is preferably constructed or otherwise configured to be horizontally level with the exposed foot peg 104 when installed. This preferred configuration allows for the floorboard 152 to be positioned at substantially the same height as the foot peg 104 with cover 106, or the preferred foot position intended by the designer of the particular vehicle, such as the CAN-AM SPYDER, RS models.

The back of the floorboard 152 includes a back tab 154 configured to be inserted into the back slot 112 of the left side aluminum assembly 102. Positioned frontwards and distally away of the back tab 154 is a back set of vertical apertures 148 and 150, configured to receive fastening means (e.g., bolts, hex bolts, screws). A front set of vertical apertures 144 and 146 configured to receive fastening means (e.g., bolts, hex bolts, screws) is positioned frontwards of the back set of vertical apertures 148 and 150. The back set of vertical apertures 148 and 150 and the front set of vertical apertures 144 and 146 can be sized to accommodate the selected fastening means and vice versa. According to one preferred embodiment, ¼ inch hex bolts can be used.

According to highly advantageous embodiments, when the back tab 154 of the left floorboard 152 is installed into the back slot 112 of the aluminum assembly 102, the back set of vertical apertures 148 and 150 are respectively aligned with the vertical apertures 168 and 166 of the foot peg 104. Once aligned, fastening means, such as bolts 138 and 140 can be passed through and secured using nuts 172 and 170. Washers can be included in the fastening means if so desired.

Similarly, when the back tab 154 of the left floorboard 152 is installed into the back slot 112 of the aluminum assembly 102, the front set of vertical apertures 144 and 146 on the floorboard 152 are respectively aligned with the vertical apertures 132 and 130 on the horizontal member 118 of the left side support bracket 116. Once aligned, fastening means, such as bolts 134 and 136 can be passed through and secured using nuts 192 and 190. Washers can be included in the fastening means if so desired.

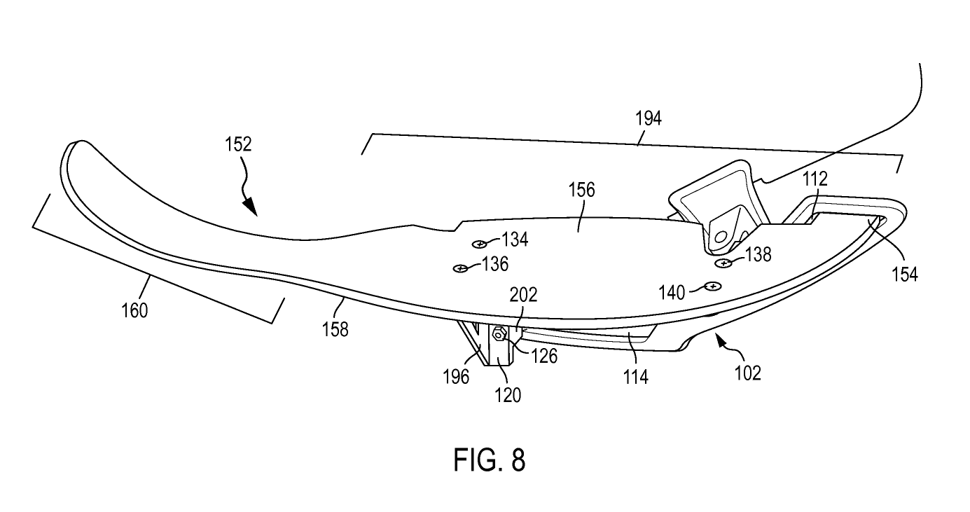

As shown in FIG. 8, with the back tab 154 installed in the back slot 112, the back set of vertical apertures 148 and 150 securely fastened to the foot peg 104, and the front set of vertical apertures 144 and 146 securely fastened to the left side support bracket 116, the left side floorboard 152 is very stable, and the horizontally leveled section 194 can easily support the entire weight of at least a 250 lb rider.

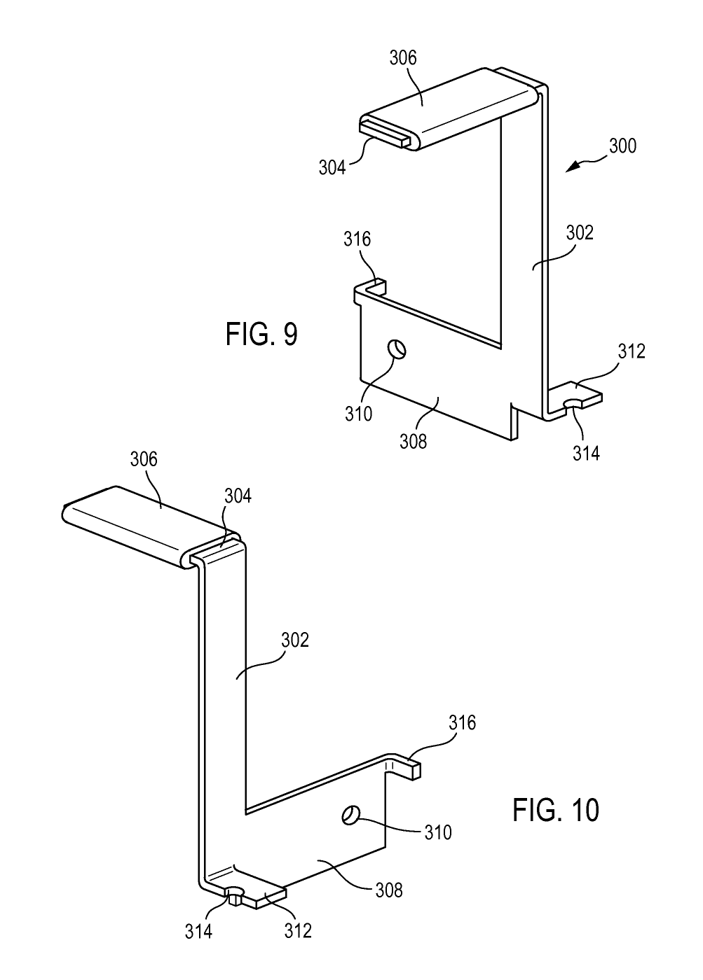

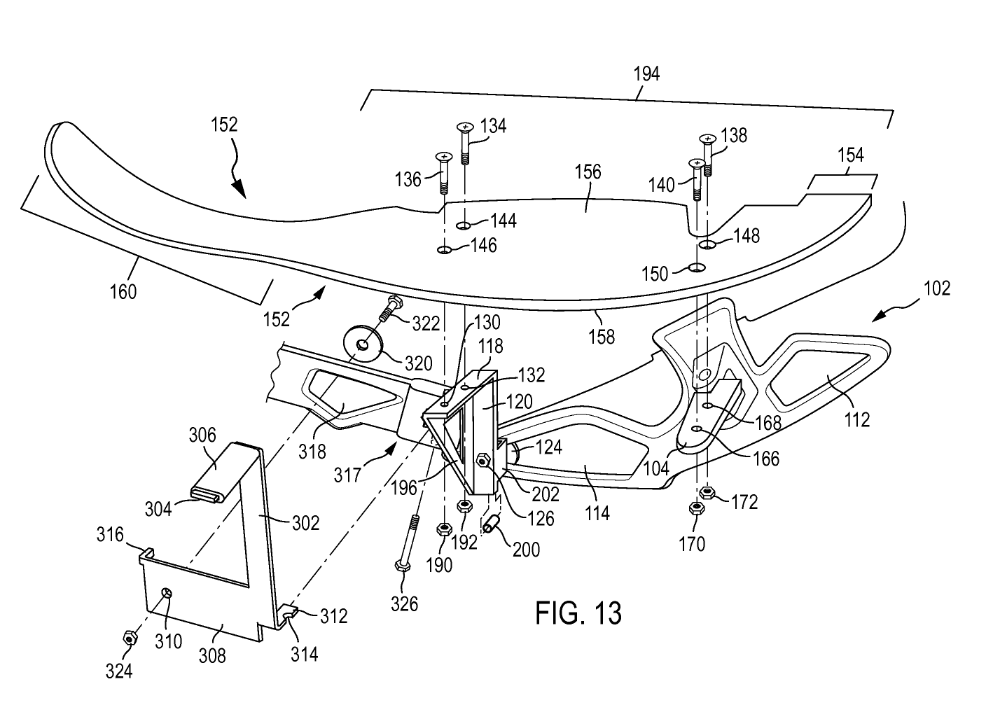

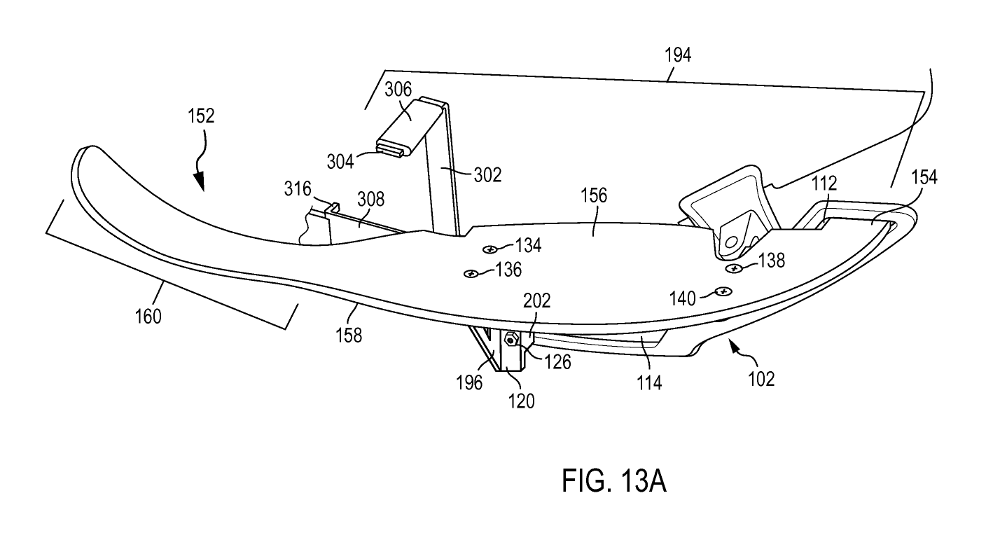

FIGS. 9-13A depicts a shift lever extender 300 and methods of installing it with vehicles that utilize a foot shifter peg 328, such as those that include manual shifting. As described herein, the left side floorboards 152 provided herein can accommodate this type of transmission. According to more specific embodiments, the shift lever extender 300 includes a horizontal member 308 having a back end coupled to a vertical member 302 configured to extend upward beyond the plane of the horizontally leveled section 194 of the floorboard 152 when installed. The horizontal member 308 includes one or more horizontal apertures 310 for allowing fastening to the vehicle. The horizontal member 308 can also include an upper, front tab 316 that is configured to rest on top of the shifter assembly 317 into a slot within the vehicle and a lower, back tab 312 that is configured to insert into the hole 330 that foot shifter peg 328 locks into. The top of the vertical member 302 preferably includes a foot extension 304 which can optionally be sheathed in a rubber cover 306, or include other non-slippage texturing or covering. When installed, as shown in FIG. 13A, the foot extension 304 is configured to be at a height above the horizontally leveled section 194 that allows the rider to position their left foot underneath it (i.e., between the upper surface of the floorboard 156 and the foot extension 304). When the shift lever extension 300 is installed, the rider can shift upwards by raising their foot which is positioned between the upper surface of the floorboard 156 and the foot extension 304. Additionally, the rider can shift downwards by stepping on top of the foot extension 304 or the cover 306 of the foot extension.

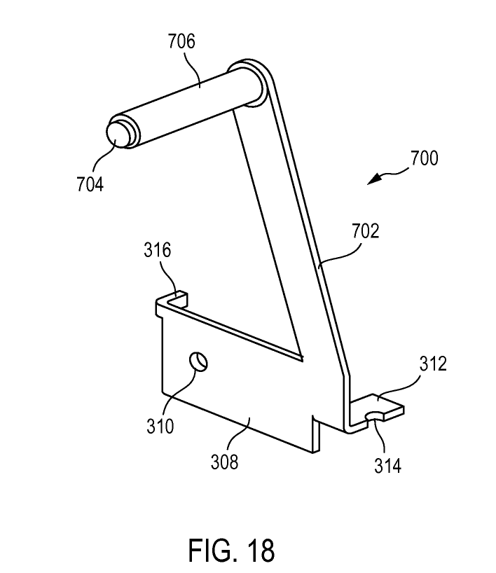

FIG. 18 depicts an alternative shaped shift lever extension 700. Instead of having a vertical member 302, this shift lever extension 700 includes an upward and forwardly angled member 702 that couples to a cylindrical foot extension 704, having a cylindrical rubber cover 706. When installed, the cylindrical foot extension 704 is configured to be at a height above the horizontally leveled section 194 that allows the rider to position their left foot underneath it (i.e., between the upper surface of the floorboard 156 and the cylindrical foot extension 704). When the alternate shift lever extension 700 is installed, the rider can shift upwards by raising their foot which is positioned between the upper surface of the floorboard 156 and the cylindrical foot extension 704. Additionally, the rider can shift downwards by stepping on top of the cylindrical foot extension 704 or the cover 706 of the cylindrical foot extension 704. Materials and Methods of making and installing the shift lever extension 700 can be the same as those described for the shift lever extension 300.

FIG. 11 shows one type of shifter assembly 317 that includes a front slot 318, and a hole 330 that the foot shifter peg 328 operably couples into with the use of a bolt 326 locked into an overlapping channel 332. As shown in FIG. 13, the shifter assembly 316 is positioned in front of the left side aluminum assembly 102 on the vehicle. More specifically, the foot shifter peg 328 can include a star shape male member 329 configured to lock into a star shaped hole 330 positioned on the shifter assembly 317. The star shaped male member 329 can include a groove 331 that is configured to align with the channel 332 that allows the bolt 326 to lock the foot shifting peg 328 into place. When installing the shift lever extension 300 a user can first uninstall the foot shifter peg 328 from its hole 330, by unscrewing the locking bolt 326 from it channel 332.

Once the foot shifter peg 328 is removed, the lower, back tab 312 on the shift lever extension 300 can be positioned within the vacant hole 330. The lower, back tab 312 preferably includes means for operably locking into the foot shifter peg hole 330 to still allow for shifting into higher and lower gears. As one exemplary way, the lower, back tab 312 includes a semi-circular groove 314 that is configured to align with the locking channel 332 such that the body of the locking bolt 326 fits within the groove 314 when it is locked into the channel 332. Alternatively other lower, back tab configurations and shapes that can be inserted into the foot shifting hole 330 are also contemplated herein, non-exclusively including a star shaped tab or otherwise in the shape of the particular foot peg shifter's male member. According to highly advantageous embodiments, the lower, back tab can include a groove, annular or semi-circular, that corresponds to the channel 332 and locking bolt 326 present in the vehicle.

In addition to the lower, back tab 312 additional suitable fastening means can be used to releasably secure the shift lever extension 300 to the shifter assembly 317. FIGS. 12 and 13 depicts one, non-exclusive way that involves a bolt 322, and a complementary washer 320 and nut 324 configured to secure the shift lever extension 300 to the front slot 318 of the shifter assembly 317 through a horizontal aperture 310 positioned in the horizontal member 308. Other alternative fastening means are known in art, including the use of more than one bolt, the use of one or more threaded holes in the shift lever extension 300 configured to receive one or more bolts, and one or more securing tabs and/or bolts on the shift lever extension 300, and complementary fastening means to fasten to the shifter assembly 317. According to preferred embodiments, the shifter assembly 317 does not have to be permanently altered, such as incurring drilling or welding to secure the shift lever extension 300. Preferred fastening means and methods are readily reversible, such as through the use of releasable fasteners.

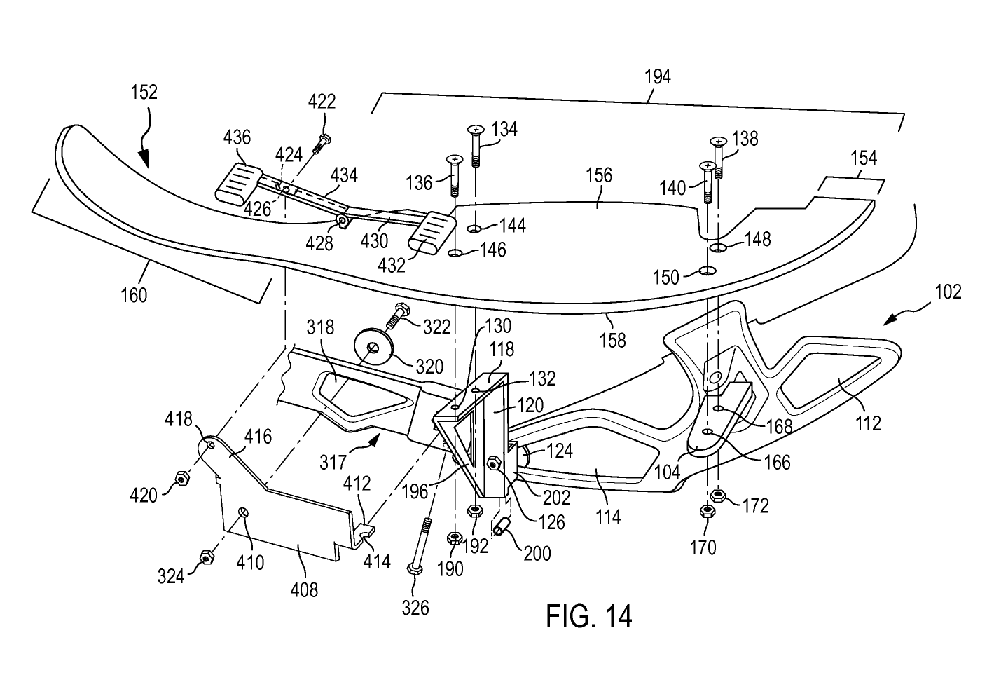

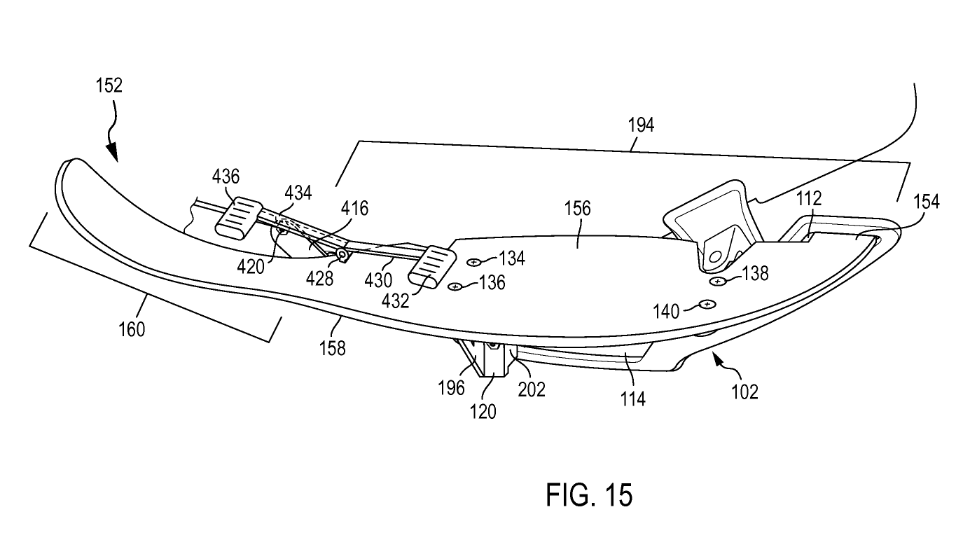

An alternative shifting option to allow heel/toe shifting is provided in FIGS. 14 and 15. A heel/toe extender 408 configured to attach to the shifting assembly 317 is shown in FIG. 14. Similar to the shift lever extension 300, the heel/toe extender includes a lower, back tab 412 that includes a semi-circular groove 414 that is configured to align with the locking channel 332 such that the body of the locking bolt 326 fits within the groove 414 when it is locked into the channel 332. Alternatively other lower, back tab configurations and shapes that can be inserted into the foot shifting hole 330 are also contemplated herein, non-exclusively including a star shaped tab or otherwise in the shape of the particular foot peg shifter's male member. According to highly advantageous embodiments, the lower, back tab can include a groove, annular or semi-circular, that corresponds to the channel 332 and locking bolt 326 present in the vehicle.

In addition to the lower, back tab 412 additional suitable fastening means can be used to releasably secure the heel/toe extender 408 to the shifter assembly 317. FIG. 14 depicts one, non-exclusive way that involves a bolt 322, and a complementary washer 320 and nut 324 configured to secure the heel/toe extender 408 to the front slot 318 of the shifter assembly 317 through a horizontal aperture 410 positioned in the heel/toe extender 408. Other alternative fastening means are known in art, including the use of more than one bolt, the use of one or more threaded holes in the heel/toe extender 408 configured to receive one or more bolts, and one or more securing tabs and/or bolts on the heel/toe extender 408, and complementary fastening means to fasten to the shifter assembly 317. According to preferred embodiments, the shifter assembly 317 does not have to be permanently altered, such as incurring drilling or welding to secure the heel/toe extender 408. Preferred fastening means and methods are readily reversible, such as through the use of releasable fasteners.

The heel/toe shifter is shown in detail in FIGS. 14 and 15. The shifter includes a pivot point 428 mounted to the top surface 156 of the left floorboard 152 operably coupled to a forward extending arm 434 supporting a toe pedal 436, and a backward extending arm 430 supporting a heel pedal 432. The forward extending arm 434 is operably coupled to the heel/toe extender 408 using any suitable fastening means. As one example the heel/toe extender 408 can include a forwardly angled, vertical extension 416 having a horizontal aperture 418 that is configured to align with a horizontal aperture 426 on the forward extending arm 434, such as through a lower tab 424 coupled to the forward extending arm 434. A bolt 422 that is configured to traverse through these apertures 426 and 418 and a complementary nut 420 can be used to secure the forward extending arm 434 to the heel/toe extender 408.

Once installed, as shown in FIG. 15, the installation is configured such that a rider pressing downward with on the toe pedal 436, shifts the vehicle to a lower gear, while pressing downwards on the heel pedal 432 shifts the vehicle into a higher gear.

The use of right and left sides herein is exemplary; those with skill in the art can readily interchange the features and steps of the assemblies and methods herein depending on the specific vehicle's orientation.

The teachings herein may be embodied in other specific forms besides and beyond those described herein. The foregoing embodiments are therefore to be considered in all respects illustrative rather than limiting, and the scope of the invention is defined and limited only by the appended claims and their equivalents, rather than by the foregoing description.

What is claimed is:

1. An assembly for releasably attaching first and second floorboards respectively onto first and second sides of a personal motorized vehicle having a brake pedal positioned on the first side comprising:
a first floorboard with an upper surface having a horizontally leveled section with a vertical aperture and an underside that includes means for releasably attaching to a topside of a first foot peg positioned on the first side of the vehicle;
a first support bracket having a horizontal extension and configured to releasably attach to the first side of the vehicle such that the horizontal extension is substantially level with the topside of the first foot peg, and wherein the horizontal extension is adapted to releasably attach to the underside of the first floorboard;
a brake extension having means for releasably attaching to the brake pedal and being configured to traverse through the vertical aperture in the first floorboard;
a second floorboard with an upper surface having a horizontally leveled section and an underside that includes means for releasably attaching to a topside of a second foot peg positioned on the second side of the vehicle;
a second support bracket having a horizontal extension and configured to releasably attach to the second side of the vehicle such that the horizontal extension is substantially level with the topside of the second foot peg, and wherein the horizontal extension is adapted to releasably attach to the underside of the second floorboard.

2. The assembly of claim 1, wherein the first and second floorboards each further comprise a back tab configured to snugly fit into a slot positioned in the first and second sides of the vehicle respectively behind the first and second foot pegs.

3. The assembly of claim 1, wherein the first and second floorboards each further comprise an upwardly angled upper surface coupled to the front of the horizontally leveled section.

4. The assembly of claim 1, wherein the vehicle further comprises a foot shifting peg operably coupled to a shifting socket on the second side of the vehicle and the assembly further comprises a shift lever extension having a male member configured to releasably attach and operably couple to the shifting socket and an extension member that traverses upwards past the horizontally leveled section of the second floor board and that is configured to allow a rider to shift upward and downward with their foot.

5. The assembly of claim 1, wherein the vehicle further comprises a foot shifting peg operably coupled to a shifting socket on the second side of the vehicle and the assembly further comprises a heel/toe extender having a male member configured to releasably attach and operably couple to the shifting socket and an extension member that traverses upwards to couple to a heel/toe shifter mounted on the horizontally leveled section of the second floor board that is configured to allow a rider to shift upward and downward with their foot.

6. The assembly of claim 1, wherein the first and second support brackets are releasably attached to the first and second sides of the vehicle in front of the first and second foot pegs, respectively

7. The assembly of claim 1, wherein the vehicle is a BRP CAN-AM SPYDER RS model.

8. A method of releasably attaching first and second floorboards respectively onto first and second sides of a personal motorized vehicle, comprising:
providing a personal motorized vehicle having a first foot peg with a topside and a brake pedal positioned on the first side and a second foot peg with a topside positioned on the second side;
providing a first floorboard with an upper surface having a horizontally leveled section with a vertical aperture to allow a brake extension to pass through and an underside;
providing a first support bracket having a horizontal extension;
providing a brake extension;
providing a second floorboard with an upper surface having a horizontally leveled section and an underside;
providing a second support bracket having a horizontal extension;
releasably attaching the first support bracket to the first side of the vehicle, such that the horizontal extension of the first support bracket is level with the topside of the first foot peg;
releasably attaching the brake extension to the brake pedal;
releasably attaching the first floorboard to the topside of the first foot peg and the horizontal extension of the support bracket such that the brake extension traverses through the vertical aperture past the upper surface of the first floorboard to allow a rider to apply pressure on the brake pedal;
releasably attaching the second support bracket to the second side of the vehicle, such that the horizontal extension of the support bracket is level with the topside of the second foot peg; and
releasably attaching the second floorboard to the topside of the second foot peg and the horizontal extension of the second support bracket.

9. The method of claim 8, wherein the first and second floorboards each further comprise a back tab, and wherein the method further comprises positioning the back tabs to snugly fit into slots positioned in the first and second sides of the vehicle behind the first and second foot pegs respectively.

10. The method of claim 8, wherein the first and second floorboards each further comprise an upwardly angled upper surface coupled to the front of the horizontally leveled section.

11. The method of claim 8, wherein the vehicle further comprises a foot shifting peg operably coupled to a shifting socket on the second side of the vehicle and the method further comprises providing a shift lever extension having a male member and an extension member, and releasably attaching and operably coupling the male member to the shifting socket such that the extension member traverses upwards past the horizontally leveled section of the second floor board and allows a rider to shift upward and downward with their foot.

12. The method of claim 8, wherein the vehicle further comprises a foot shifting peg operably coupled to a shifting socket on the second side of the vehicle and the method further comprises providing a heel/toe extender having a male member and an extension member, and releasably attaching and operably coupling the male member to the shifting socket such that the extension member traverses upwards to couple to a heel/toe shifter mounted on the horizontally leveled section of the second floor board and allows a rider to shift upward and downward with their foot.

13. The method of claim 8, wherein the vehicle is a BRP CAN-AM SPYDER RS model.
